(19) United States
(12) Patent Application Publication
(10) Pub. No.: US 2026/0309875 A1
(43) Pub. Date: Oct. 8, 2026

(54) DUAL ANTENNA SYSTEM AND METHOD

(71) Applicant: Deere & Company, Moline, IL (US)

(72) Inventors: Yunfeng SHAO, Torrance, CA (US); Michael A. ZEITZEW, Redondo Beach, CA (US); Liwen DAI, Torrance, CA (US)

(21) Appl. No.: 19/629,025

(22) Filed: Mar. 26, 2026

Related U.S. Application Data
(63) Continuation of application No. PCT/US26/20010, filed on Mar. 19, 2026.
(60) Provisional application No. 63/783,771, filed on Apr. 4, 2025.
(60) Provisional application No. 63/783,792, filed on Apr. 4, 2025.

(51) Int. Cl. G01S 19/49; G01S 19/39; G01S 19/44; H01Q 1/28; H01Q 1/32

(52) U.S. Cl. CPC G01S 19/49; G01S 19/393; G01S 19/44; H01Q 1/288; H01Q 1/3233

(57) ABSTRACT

A method includes, receiving, at each of a first antenna and a second antenna of a mobile object, satellite navigation signals from a plurality of satellites including a respective channel signal for each respective channel of the satellite navigation signals received from a respective satellite of the plurality of satellites. The method includes calculating a baseline vector between the first antenna and the second antenna using a cost function applied to a plurality of candidate integer ambiguity sets, wherein each respective candidate integer ambiguity set of the plurality of candidate integer ambiguity sets includes a respective candidate integer solution for each respective channel signal, and initializing an inertial navigation system using the baseline vector between the first antenna and the second antenna. The method includes performing a navigation function for the mobile object using the initialized inertial navigation system.

### RELATED AND PRIORITY APPLICATIONS

This application is a continuation of PCT/US26/20010, filed Mar. 19, 2026, which claims priority to U.S. Provisional App. No. 63/783,771, filed Apr. 4, 2025, and U.S. Provisional App. No. 63/783,792, each of which is incorporated by reference herein in its entirety.

### TECHNICAL FIELD

The disclosed embodiments relate generally to a global navigation satellite systems (GNSS) and more specifically, to systems and methods for determining states of a GNSS receiver (e.g., ambiguity solutions, the attitude of a vehicle) using GNSS measurements using two antennas.

### BACKGROUND

Global Navigation Satellite Systems (GNSS), such as Global Positioning System (GPS), the Global Orbiting Navigation Satellite System (GLONASS), the European Galileo and European Geostationary Navigation Overlay Service (EGNOS), Chinese BeiDou System (BDS), the Wide Area Augmentation System (WAAS), and Japanese Quasi-Zenith Satellite System (QZSS), are used in many applications.

In a GNSS system, each satellite transmits a signal that identifies the satellite and allows a receiver to determine the time at which the signal was sent. To do so, a GNSS satellite transmits a pseudorandom code (PN code) (also called a pseudorandom noise code (PRN code)). The PN code is, for example, a series of ones and zeroes that looks random, but in fact uniquely identifies the satellite. The GNSS receivers acquire and track the GNSS satellite signals. From its code and carrier tracking loops, a GNSS receiver can then generate range or range rate measurements, such as pseudorange measurements, carrier phase measurements and doppler shift measurements. In some instances, using other data, such as ephemeris data and almanac data, that is encoded in the received signal, “on top of” the pseudorandom code, using various modulation schemes (e.g., binary phase shift keying (BPSK), binary offset carrier (BOC)), the receiver can determine the time at which the signal was sent by the satellite. Using signals received from four or more satellites, the receiver can determine its position (e.g., on Earth).

GNSS receivers can provide very accurate drift-free position solutions to the end users. However, without augmentation, GNSS receivers lack the capability to solve for platform attitude solutions, while a GNSS-aided inertial navigation systems (INSs) can provide a full attitude solution.

### SUMMARY

Some embodiments of the present disclosure relate to GNSS systems having a receiver that receives signals from two GNSS antennas, located at different fixed positions on a vehicle. In some embodiments, a priori knowledge of the fixed positions of the GNSS antennas is used to determine states of the vehicle, such as an ambiguity solution for the antennas (e.g., solutions to the integer ambiguity problem for the various signals received by the two antennas) and/or an attitude of the vehicle. In some embodiments, the ambiguity solution is tracked in a Kalman filter, which also provides navigational updates for the vehicle. To that end, the present disclosure provides a baseline length constraint for determining an ambiguity solution for the various GNSS signals received by the two antennas, which may use a search and shrink strategy to identify the ambiguity solution. A quadratic cost function is provided for a LAMBDA method, which further simplifies the solution. In addition, in accordance with some embodiments, double difference values in observable quantities between two antennas are used to determine the ambiguity solution, which allows the secondary antenna to operate at a single-frequency secondary antenna, thus reducing the computational load and potential system cost. Further, in accordance with some embodiments, a determined baseline vector between the two antennas may be used to initialize and/or calibrate an INS system.

In accordance with some embodiments, a method for navigating a mobile object according to signals from satellites (e.g., using a quadratic cost function) is provided. The method includes, at the mobile object having a first antenna and a second antenna located a constant distance from the first antenna: receiving, at each of the first antenna and the second antenna, satellite navigation signals from a plurality of satellites including a respective channel signal for each respective channel of the satellite navigation signals received from a respective satellite of the plurality of satellites. The method further includes acquiring, for the satellite navigation signals received by the first antenna and the second antenna, a solution to an integer ambiguity for each respective channel signal, including: calculating, for a plurality of candidate integer ambiguity sets, wherein each respective candidate integer ambiguity set of the plurality of candidate integer ambiguity sets includes a candidate integer solution for each respective channel signal: a baseline vector between the first antenna and the second antenna; a value for a cost function, calculated using the baseline vector between the first antenna and the second antenna, wherein the cost function is quadratic with respect to the respective integer ambiguity set, wherein the cost function includes an a priori fixed baseline length and an uncertainty value for the a priori fixed baseline length; and selecting, based in part on the values of the quadratic cost function for the plurality of candidate integer ambiguity sets, a solution integer ambiguity set. The method includes performing a navigation function for the mobile object in accordance with the selected integer ambiguity set.

In accordance with some embodiments, a method for navigating a mobile object according to signals from satellites (e.g., using a baseline change accumulation according to double difference values), is provided. The method is performed at the mobile object having a first antenna and a second antenna located a distance from the first antenna, The second antenna provides received single-frequency signals to a receiver. The method includes receiving, at each of the first antenna and the second antenna, satellite navigation signals from a plurality of satellites including a respective channel signal for each respective channel of the satellite navigation signals received from a respective satellite of the plurality of satellites. The method includes calculating a respective baseline change between the first antenna and the second antenna based on double difference values comprising differences in one or more corresponding observables for a respective satellite navigation signal between (i) the first antenna and the second antenna and (ii) adjacent time periods, as received by the second antenna. The method includes determining a respective baseline vector between the first antenna and the second antenna using, at least in part, the baseline change. The method includes performing a navigation function for the mobile object using baseline vector.

In accordance with some embodiments, a method for navigating a mobile object according to signals from satellites (e.g., by initializing an INS using a baseline vector between two antennas) is provided. The method includes, at the mobile object having a first antenna and a second antenna located a distance from the first antenna, receiving, at each of the first antenna and the second antenna, satellite navigation signals from a plurality of satellites including a respective channel signal for each respective channel of the satellite navigation signals received from a respective satellite of the plurality of satellites. The method includes calculating a baseline vector between the first antenna and the second antenna using a cost function applied to a plurality of candidate integer ambiguity sets, wherein each respective candidate integer ambiguity set of the plurality of candidate integer ambiguity sets includes a respective candidate integer solution for each respective channel signal and initializing an inertial navigation system using the baseline vector between the first antenna and the second antenna. The method includes performing a navigation function for the mobile object using the initialized inertial navigation system.

In accordance with some embodiments, a navigation module, or a global navigation satellite system (GNSS) receiver, or a device includes one or more processors and memory. The memory stores instructions that, when executed by the one or more processors, cause the navigation module, or GNSS receiver, or device, to perform any of the methods disclosed herein.

In accordance with some embodiments, a computer-readable storage medium is provided that stores instructions which, when executed by a navigation module, or a global navigation satellite system (GNSS) receiver, or a device, that includes one or more processors, cause the navigation module, or the GNSS receiver, or the device, to perform any of the methods described herein.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating a navigation system, according to some embodiments.

FIG. 1B illustrates a block diagram of a GNSS receiver in accordance with some embodiments.

FIG. 1C is a block diagram of a computer system, such as a computer system that is part of a moveable object's navigation system, according to some embodiments.

FIG. 2 illustrates a block diagram of a dual antenna architecture in accordance with some embodiments.

FIGS. 3A-3B illustrate plan and elevation views of a system that mounts two antennas on a mobile object that are used to initialize an inertial navigation system (INS), in accordance with some embodiments.

FIGS. 4A-4B illustrate a flowchart diagram for a method for navigating a mobile object according to signals from satellites (e.g., by initializing an INS using a baseline vector between two antenna), in accordance with some embodiments.

### DESCRIPTION OF EMBODIMENTS

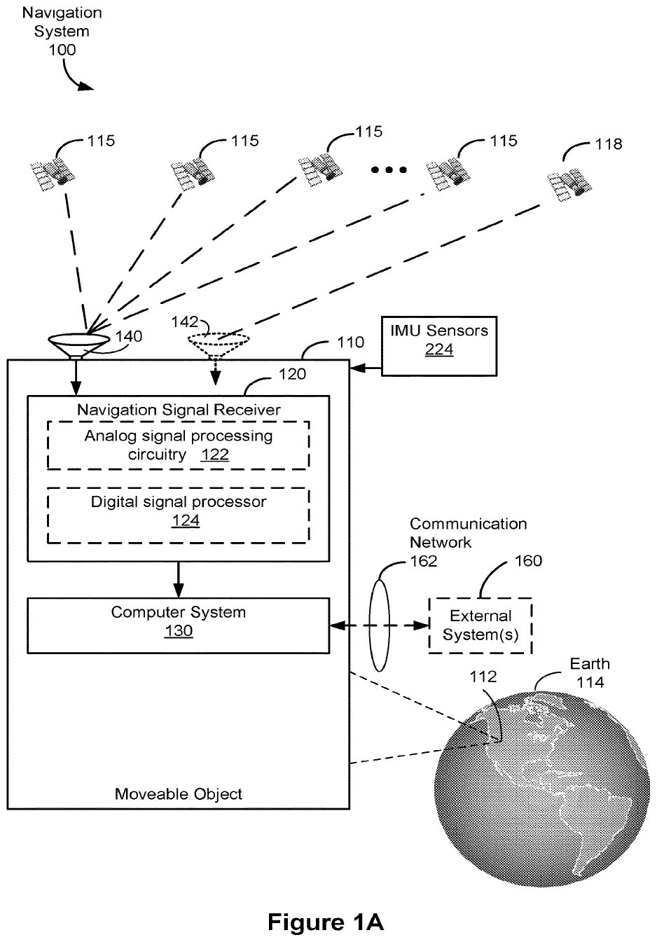

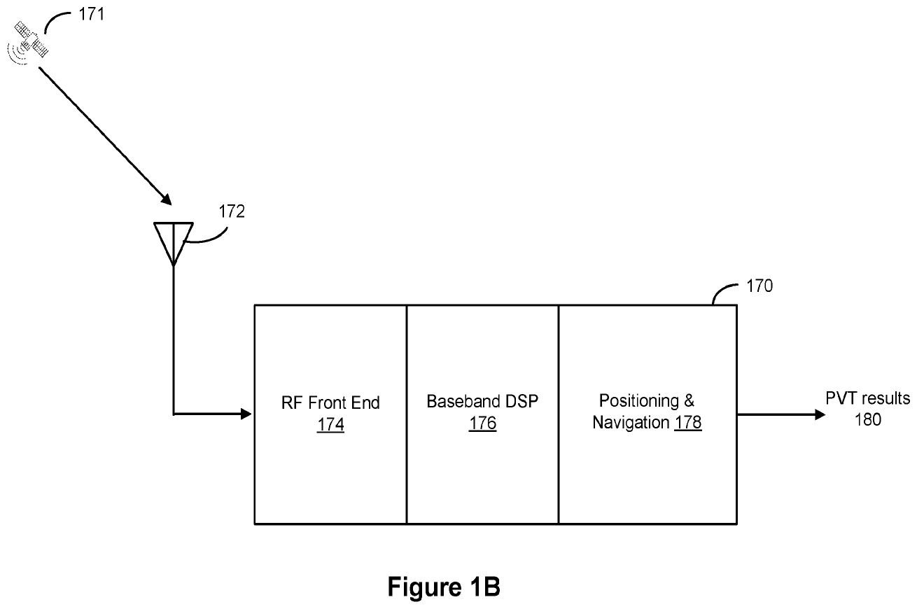

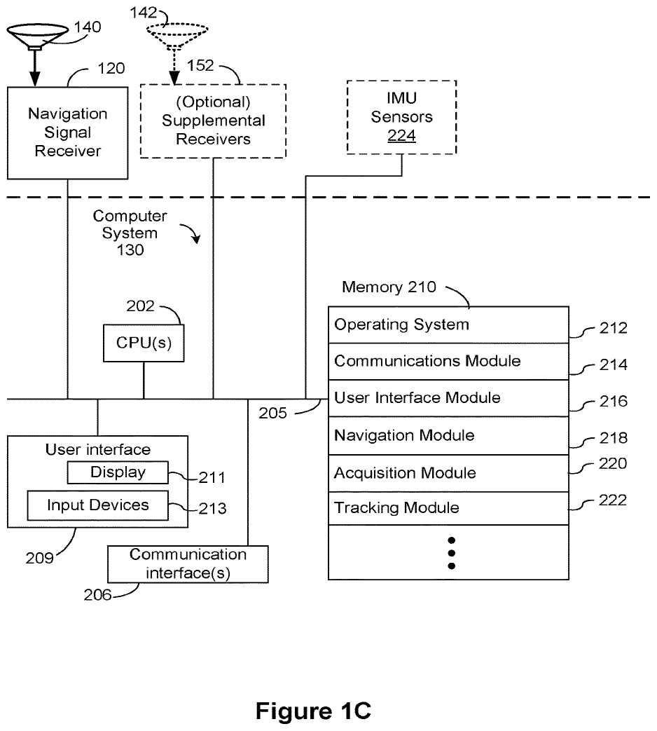

FIG. 1A is a block diagram illustrating a navigation system 100, according to some embodiments. Navigation system 100 enables a moveable object 110 (e.g., a phone, specialized GNSS receiver, a boat, a truck or other vehicle, a farming appliance, mining appliance, drilling system, etc.) to determine, at any point of time, its current position 112 with respect to a global coordinate system (e.g., a coordinate system for Earth 114). Moveable object 110 is equipped with a satellite receiver (navigation signal receiver 120), typically including or coupled to one or more satellite antennas 140, to receive satellite navigation signals from at least four satellites 115 that are orbiting Earth. The satellite navigation signals received by moveable object 110 are typically global navigation satellite system (GNSS) signals.

Moveable object 110 optionally receives satellite orbit correction information and satellite clock correction information (sometimes collectively called “correction information”) for the plurality of satellites. The correction information is typically broadcast by and received from one or more satellites 118 distinct from the GNSS satellites 115, using an antenna 142 and signal receiver 152 (see FIG. 1C) distinct from antenna 140 and navigation signal receiver 120 used to receive the satellite navigation signals. However, in some embodiments, the same antenna and receiver are used to receive both satellite navigation signals and correction information.

Moveable object 110 determines a position of moveable object 112, using the received satellite navigation signals and, optionally, the received satellite orbit correction information and satellite clock correction information for the plurality of satellites. In some embodiments, received satellite navigation signals are processed by navigation signal receiver 120, including analog signal processing circuitry 122 and a digital signal processor 124, optionally taking into account the correction information, to determine code measurements and phase measurements for signals received from four or more satellites 115. Embedded computer system 130 determines the position of moveable object 110 based on those measurements.

FIG. 1B illustrates a block diagram of an example GNSS receiver 170 (e.g., navigation signal receiver 120) in accordance with some embodiments. The GNSS receiver 170 receives signals from one or more GNSS satellites (e.g., GNSS satellite 171), processes the signals, and delivers Position, Velocity and Time (PVT) results 180. In some embodiments, the GNSS receiver 170 includes an antenna 172, a radio frequency (RF) front end module 174, a baseband digital signal processing (DSP) module 176, and a positioning and navigation module 178. The antenna 172 is the first stage of the GNSS receiver 170 and receives RF signals from all visible GNSS satellites. In some embodiments, the antenna 172 is equipped with a built-in amplifier. In some embodiments, the GNSS receiver 170 is equipped with multiple antennas or an antenna array. The received RF signals are filtered, amplified, down-converted, and digitized by the RF front end module 174. The RF front end module 174 typically includes one or more stages of down-conversions and filters, to convert the RF signals to different intermediate frequency (IF) bands with designated bandwidths while excluding out-of-band interferences. The final filter in high-precision GNSS receivers typically has a wide bandwidth (e.g., 30 MHz or more). Analog-to-digital (A/D) converters in the RF front end module convert received analog signals, e.g., from the final filter, into digital Intermediate Frequency (IF) signals. In some embodiments, the RF front end electronics 174 are integrated into a RF Application-Specific Integrated Circuit (ASIC) chip.

The RF front end module 174 outputs digital IF signals, which are processed by the baseband DSP module 176. By processing the digital IF signals, the baseband DSP module 176 acquires and tracks each individual visible satellite (e.g., each satellite for which there is a direct line of sight to the receiver 170), generates range measurements, including code phase measurements (and therefore pseudorange measurements), carrier phase measurements and doppler measurements, and decodes navigation data bits encoded in the signal(s) received from each satellite. According to some embodiments of the present disclosure, phase multipath mitigation is performed by the baseband DSP module 176. In some embodiments, the baseband DSP module 176 comprises both hardware and firmware, but the division of these two portions is often not clearly defined and depends on a variety of design considerations. In some embodiments, the baseband DSP electronics are integrated into a baseband ASIC chip. In some embodiments, the RF front-end electronics and the baseband DSP electronics are integrated into a single-die System-On-Chip (SOC) chip.

The baseband DSP module 176 outputs range measurements and navigation data that are used by the positioning and navigation module 178 to calculate PVT results 180. In some embodiments, the PVT results 180 are used by user applications. In some embodiments, the positioning and navigation module 178 is implemented in software executed by a microprocessor, while the firmware portion of the baseband DSP module 176 is implemented in either the same microprocessor as the microprocessor of the positioning and navigation module 178, or in a separate microprocessor. In some embodiments, the GNSS receiver 170 includes more than one microprocessor.

FIG. 1C is a block diagram of computer system 130 in, and used by, a moveable object (e.g., moveable object 110, FIG. 1A) to determine the position of the moveable object, according to some embodiments.

Computer system 130 typically includes one or more processors (sometimes called CPUs, or hardware processors) 202 for executing programs or instructions; memory 210; one or more communications interfaces 206; and one or more communication buses 205 for interconnecting these components. Computer system 130 optionally includes a user interface 209 comprising a display device 211 and one or more input devices 213 (e.g., one or more of a keyboard, mouse, touch screen, keypad, etc.) coupled to other components of computer system 130 by the one or more communication buses 205. Navigation signal receiver 120 (or GNSS receiver 170), supplemental receiver(s) 152, if provided, and IMU sensors 224 (e.g., accelerometers and/or gyroscopes, and optionally magnetometers), are also coupled to other components of computer system 130 by the one or more communication buses 205. The one or more communication buses 205 may include circuitry (sometimes called a chipset) that interconnects and controls communications between system components. The combination of navigation signal receiver 120, computer system 130, antenna 140, optionally antenna 142), and IMU sensors 224 is sometimes herein called a navigation system or a navigation system for a moveable object.

Communication interface 206 (e.g., a receiver or transceiver) is used by computer system 130, and more generally moveable object 110, to convey information to external systems (e.g., external system(s) 160, FIG. 1A), and to receive communications from external systems.

Memory 210 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 210 optionally includes one or more storage devices remotely located from the CPU(s) 202. Memory 210, or alternately the non-volatile memory device(s) within memory 210, comprises a computer readable storage medium (e.g., a non-transitory computer readable storage medium). In some embodiments, memory 210 or the computer readable storage medium of memory 210 stores the following programs, modules and data structures, or a subset thereof:
an operating system 212 that includes procedures for handling various basic system services and for performing hardware dependent tasks;
a communications module 214 that operates in conjunction with communication interface 206 (e.g., a receiver and/or transceiver) to handle communications between moveable object 110 and external systems 160 (FIG. 1); the connection between computer system 130 and external systems 160 may include a communication network 162, such as the internet or a public or proprietary wireless network;
optionally, a user interface module 216 for receiving information from one or more input device 213 of user interface 209, and to convey information to a user of moveable object 110 via one or more display or output devices 211;
a navigation module 218 for determining a position of the moveable object and performing one or more navigation functions (e.g., routing of the mobile object;
displaying on a map one or more suggested routes for moving the mobile object from a current location to a specified or target location; and/or providing information regarding locations nearby the mobile object or along a proposed route of the mobile object);
an acquisition engine 220 for acquiring satellite signals from GNSS satellites, including determining a tracking frequency and a code shift (sometimes called a code offset) for each of several respective GNSS satellites, or for managing operation of an acquisition engine that is implemented, at least in part, in digital signal processor 124; and
a tracking module 222, sometimes called the satellite signal tracking module, which tracks GNSS satellite signals using acquisition information (e.g., the tracking frequency and code shift) handed over from the acquisition module 220, or for managing operation of a tracking module that is implemented, at least in part, in digital signal processor 124. For example, in some embodiments, tracking module 222 samples a GNSS satellite signal using a tracking frequency and code shift initially determined by the acquisition module 220, and then adjusted by the tracking module itself as the tracking module determines code phase corrections for respective channels of the received satellite navigation signals.

Operating system 212 and each of the above identified modules and applications correspond to a set of instructions for performing a function described above. The set of instructions can be executed by the one or more processors 202 of computer system 130. The above identified modules, applications or programs (i.e., sets of instructions) need not be implemented as separate software programs, procedures or modules, and thus various subsets of these modules may be combined or otherwise re-arranged in various embodiments. In some embodiments, memory 210 stores a subset of the modules and data structures identified above. Furthermore, memory 210 optionally stores additional modules and data structures not described above.

FIG. 1C is intended more as a functional description of the various features which may be present in a computer system 130 of a moveable object 110 than as a structural schematic of the embodiments described herein. In practice, and as recognized by those of ordinary skill in the art, items shown separately could be combined and some items could be separated. For example, some items shown separately in FIG. 1C could be combined into a single module or component, and single items could be implemented using two or more modules or components. The actual number of modules and components, and how features are allocated among them will vary from one implementation to another.

In addition, in some embodiments, some or all of the above-described functions may be implemented with hardware circuits (e.g., which may comprise graphics processors for efficiently performing discrete Fourier transforms (DFTs), field programmable gate arrays (FPGAs), application specific integrated circuits (ASICs), a “system on a chip” that includes processors and memory, or the like). To that end, in some embodiments, CPUs 202 include specialized hardware for performing these and other tasks. In some embodiments, some of the operations described above with respect to computer system 130 are performed by navigation signal receiver 120 and/or GNSS receiver 170 rather than computer system 130.

### GNSS Dual Antenna System

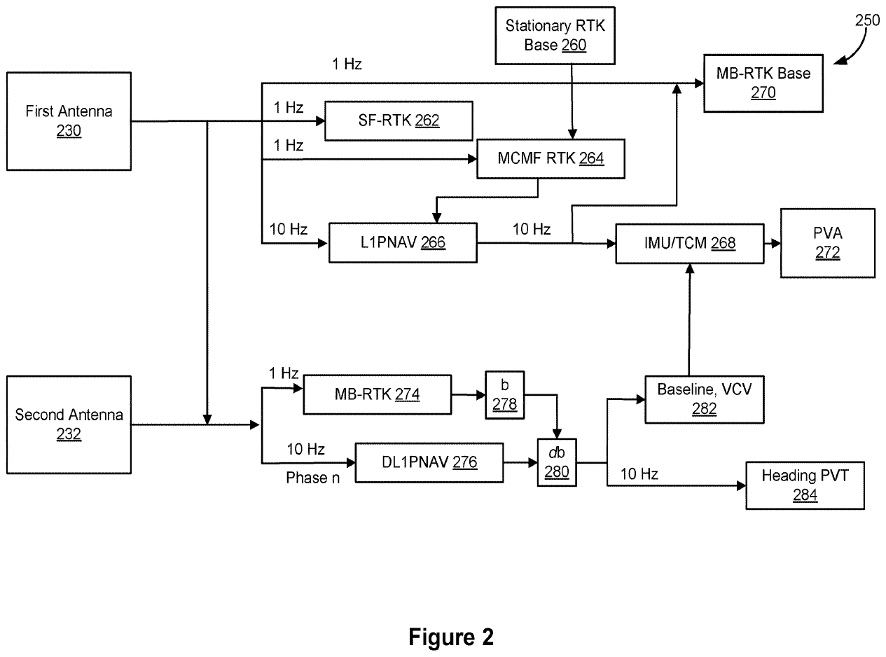

FIG. 2 illustrates a block diagram of the architecture of a dual antenna system 250 (e.g., a navigation system having dual antennas) in accordance with some embodiments. In some embodiments, the dual antenna system 250 is made up of primary antenna (e.g., first antenna 230) and one or more secondary antennas (e.g., second antenna 232) with an optional stationary RTK base correction (e.g., from stationary RTK base 260) as an input. In some embodiments, one or more modules, including StarFire-RTK (SF-RTK 262) (e.g., a Wide Area Differential GNSS system), Multi-Constellation Multi-Frequency (MCMF) RTK 264 and L1PNAV 266 are used to process primary antenna measurements to provide real-time position, velocity, and acceleration (PVA 272) of the primary antenna (e.g., at a high-rate, such as 10 Hz or another rate greater than 1 Hz). Note that L1PNAV refers to a navigation module for the GPS L1 system, and is thus an example of such a module. One of skill in the art, having the benefit of this disclosure, will understand that other types of signals, besides the GPS L1 signal, may be used.

FIG. 2 illustrates two additional modules including MB-RTK (moving base RTK 274) and DL1PNAV (differential L1PNAV 276, also referred to as a dual antenna delta position change module) that process aspects of primary and secondary antenna GNSS measurements to provide precise relative position and orientation for the secondary antenna (e.g., at a high-rate, such as 10 Hz). More specifically, MB-RTK 274 generates a baseline vector b 278, representing a relative baseline (spatial) vector between the first antenna and the second antenna. In some embodiments, the DL1PNAV module 276 is used to estimate an accumulated position change (db 280) over an epoch updated at a higher rate (e.g., 0.1 second, or 10 Hz) for computing the relative baseline vector between the first antenna 230 and the second antenna 232. In some embodiments, the position and orientation for the secondary antenna is integrated with primary antenna position from either SF-RTK module 262 or MCMF-RTK module 264, such that the second antenna's real-time position, velocity and heading can be output in real-time. The relative baseline vector, as well as a corresponding variance/covariance matrix 282 is integrated with Inertial Measurements Unit (IMU/Terrain Compensation module (TCM) 268) for determining a robust attitude of the vehicle on which the antennas are mounted (shown as heading PVT 284), even during GNSS measurements outages.

FIG. 2 illustrates example frequencies at which certain signals may be pass and/or processed. In general, the signals labeled “1 Hz” are considered low-rate (epoch) signals in this disclosure, whereas the signals labeled “10 Hz” are considered high-rate signals. Other frequencies, besides 1 Hz and 10 Hz, may be used for the low-rate and high-rate signals.

As such, in some embodiments, the dual antenna system provided in FIG. 2 adds a more extensive computation load to provide reliable and accurate positions of the dual antenna at a high-rate. Further, in some embodiments, a single-frequency secondary antenna is used to reduce the computation load and potential system cost. This has motivated the development of the embodiments described in detail in the following sections.

### GNSS Raw Measurements

In some embodiments, the basic GNSS observables from both primary and secondary antenna are the code and carrier phase measurements between a GNSS satellite s and a receiver r:

$${P}_{r , {L}_{1}}^{s} = {D}_{r}^{s} + {I}_{r , {L}_{1}}^{s} + {B}_{r , {L}_{1}} - {B}_{{L}_{1}}^{s} + {ε}_{{P}_{r , {L}_{1}}^{s}} \qquad ( 1 )$$

$${Φ}_{r , {L}_{1}}^{s} {λ}_{{L}_{1}} = {D}_{r}^{s} + {δ}_{pwu} {λ}_{{L}_{1}} - {I}_{r , {L}_{1}}^{s} + {N}_{r , {L}_{1}}^{s} {λ}_{{L}_{1}} + {b}_{r , {L}_{1}} - {b}_{{L}_{1}}^{s} + {ε}_{{Φ}_{r , {L}_{1}}^{s}} \qquad ( 2 )$$

$${P}_{r , {L}_{2}}^{s} = {D}_{r}^{s} + \frac{{f}_{{L}_{1}}^{2}}{{f}_{{L}_{2}}^{2}} {I}_{r , {L}_{1}}^{s} + {B}_{r , {L}_{2}} - {B}_{{L}_{2}}^{s} + {ε}_{{P}_{r , {L}_{2}}^{s}} \qquad ( 3 )$$

$${Φ}_{r , {L}_{2}}^{s} {λ}_{{L}_{2}} = {D}_{r}^{s} + {δ}_{pwu} {λ}_{{L}_{2}} - \frac{{f}_{{L}_{1}}^{2}}{{f}_{{L}_{2}}^{2}} {I}_{r , {L}_{1}}^{s} + {N}_{r , {L}_{2}}^{s} {λ}_{{L}_{2}} + {b}_{r , {L}_{2}} - {b}_{{L}_{2}}^{s} + {ε}_{{Φ}_{r , {L}_{2}}^{s}} \qquad ( 4 )$$

$${P}_{r , {L}_{3}}^{s} = {D}_{r}^{s} + \frac{{f}_{{L}_{1}}^{2}}{{f}_{{L}_{3}}^{2}} {I}_{r , {L}_{1}}^{s} + {B}_{r , {L}_{3}} - {B}_{{L}_{3}}^{s} + {ε}_{{P}_{r , {L}_{3}}^{s}} \qquad ( 5 )$$

$${Φ}_{r , {L}_{3}}^{s} {λ}_{{L}_{3}} = {D}_{r}^{s} + {δ}_{pwu} {λ}_{{L}_{3}} - \frac{{f}_{{L}_{1}}^{2}}{{f}_{{L}_{3}}^{2}} {I}_{r , {L}_{1}}^{S} + {N}_{r , {L}_{3}}^{s} {λ}_{{L}_{3}} + {b}_{r , {L}_{3}} - {b}_{{L}_{3}}^{s} + {ε}_{{Φ}_{r , {L}_{3}}^{s}} \qquad ( 6 )$$

where:
subscripts denote the applicable frequency associated with a quantity as follows:
[ ]_{L}_{₁}, refers to the first frequency of each GNSS system such as GPS/QZSS L₁, Galileo E₁, Beidou B_{b1c} and Glonass FDMA signal L_{G1},
[ ] _{L}_{₂} refers to the second frequency of each GNSS system such as GPS/QZSS L₂, Galileo E₅, Beidou B₂ₐ and Glonass FDMA signal L_{G2},
[ ]_{L}_{₃}, refers to the third frequency of each GNSS system such as GPS/QZSS L₅, Galileo E₆, Beidou B₃ and Glonass code division multiple access (CDMA) signal L_{30C},
I is ionospheric delay error,
ε is measurement noise including any un-modeled multipath etc.

$${D}_{r}^{s}$$

represents the common term

$${D}_{r}^{s} = {ρ}_{r}^{s} + {τ}_{r} - {τ}^{s} + {T}_{r}^{s} + {δ}_{pcv / pco} + {δ}_{tides} + {δ}_{rel} + {δ}_{shapiro} \qquad ( 7 )$$

where

$${ρ}_{r}^{s}$$

is the geometric distance from the receiver r phase center to the satellite s phase center;
τᵣ is the receiver clock error;
τ^{s} is the satellite clock error;

$${T}_{r}^{s}$$

is the tropospheric effect;
δ_{pcv/pco} is the antenna phase delay due to receiver phase center offset and variation, and satellite antenna phase center offset and variation;
δ_{pwu} is the phase wind up due to relative changing orientation between satellite and receiver antennas;
δ_{tides} is the tidal effect including solid earth tide, ocean tides loading, polar tide loading, etc.;
δᵣₑₗ is relativistic effect on satellite clock; and
δₛₕₐₚᵢᵣₒ is relativistic effect on signal propagation, i.e., Shapiro delay.

In some embodiments, the satellite-receiver geometric distance p is obtained by solving a “light-time equation.” In some embodiments, the equation contains the satellite movement effect during signal propagation and the received time offset by the receiver clock bias. In some embodiments, the primary antenna includes triple frequency measurements from the GNSS system including GPS, Galileo, Beidou, GLONASS and/or QZSS systems. In some embodiments, the secondary antenna includes high band GNSS measurements.

In some embodiments, SF-RTK functionality enables StarFire receivers to achieve centimeter-level navigation accuracy using global StarFire correction signals. For example, the upgraded StarFire GNSS system not only significantly improves the StarFire GNSS orbit and clock correction accuracy and reliability, but also provides additional bias correction signals to enable receivers' quick convergence to centimeter-level navigation accuracy. At the same time, MCMF RTK model was developed to improved conventional RTK accuracy and reliability using GNSS systems including GPS, Galileo, Beidou, GLONASS and QZSS systems.

In some embodiments, a simple and very efficient module called L1PNAV is used for propagating the position forward in time at a high rate. Because the L1PNAV algorithm uses the change in carrier-phase measurements at the high-rate epoch interval, it is very accurate and does not limit the accuracy when used in even the highest precision RTK or StarFire precise point positioning (PPP) mode.

### Moving Base RTK Algorithm Design

The following describes the major components of the system illustrated in FIG. 2 as it pertains specifically to processing measurements between primary antenna and secondary antenna, in particular: moving base RTK (MB-RTK) float solution, Baseline Constraint with Ambiguity Resolution, and differential Navigation High-Rate Update.

Unlike conventional Real-Time Kinematic (RTK), which requires a stationary base receiver to broadcast RTK correction (raw measurements) data to the rover receiver, the moving base RTK (MB-RTK) no longer requires the base receiver to be stationary. By allowing both the base and rover receiver to be moving and maintaining a centimeter level accurate 3-D baseline vector solution between the dual antenna, the moving base RTK can be used in a wide range of applications where the precise relative position and heading between two or more moving objects (e.g., vehicles or other objects) is needed. In some embodiments, the primary antenna location is determined using either RTK or SF-RTK navigation mode. For example, the primary antenna location is used as a moving base location, where single-frequency GNSS measurements (e.g., provided according to Eq (1) and (2)) from dual antennas can be processed using moving base RTK algorithms. In some embodiments, the baseline is within a threshold distance (e.g., within a few meters). In some embodiments, both ionospheric delay and tropospheric delay are ignored. In some embodiments, the same receiver TCXO oscillator is shared for the dual antenna system. In some embodiments, the time update and measurement update of the Kalman filter are performed using techniques well-known to those skilled in the art of GNSS navigation principles. The measurements input to the filter are the single-differentiated measurements between dual antennas as following Equations (8-9),

$$Δ {P}_{r , {L}_{1}}^{s} = Δ {ρ}_{r}^{s} + Δ {τ}_{r} + Δ {ε}_{{P}_{r , {L}_{1}}^{s}} \qquad ( 8 )$$

$$Δ {Φ}_{r , {L}_{1}}^{s} {λ}_{{L}_{1}} = Δ {ρ}_{r}^{s} + Δ {τ}_{r} + Δ {N}_{r , {L}_{1}}^{s} {λ}_{{L}_{1}} + Δ {ε}_{{Φ}_{r , {L}_{1}}^{s}} \qquad ( 9 )$$

In some embodiments, the Kalman filter state vector includes the collection of relative baseline, receiver clock bias state for each GNSS system (e.g., one or more GNSS systems for which channel signals are being tracked), and float ambiguity states for each GNSS satellite. In some embodiments, the same physical GNSS frequency (e.g., GPS L1, Glonass G1, Galileo E1 and Beidou BIC and QZSS L1) is used by both antennas, such that a common receiver bias state can be used. For example, using the common (i.e., shared) TCXO oscillator for the dual antennas, the receiver clock oscillator impact is cancelled after single-differential operation between the two antennas while the clock bias state remains relative constant. It will be understood that other states may be added or modified from the measurement models presented here if multi-frequency measurements are processed.

### Baseline Constraint Within Ambiguity Search

In some embodiments, the ambiguity state (e.g., the solution to the integer ambiguity) is estimated in a Kalman filter. In some embodiments, the ambiguity state is a single differentiated float value AN between a satellite and a receiver. The AN include the receiver phase wind-up and receiver phase biases. In some circumstances, only the double-differenced integer ambiguity between satellite and antenna can be fixed into an integer value. In some embodiments, the highest elevation satellite is selected as the reference satellite. In some embodiments, the double-differenced ambiguity and variance-covariance (VCV) are derived based on single differential float ambiguity states and variance-covariance after a reference satellite for each constellation is chosen. In some embodiments, the common (i.e., shared) reference satellite for GPS L1, Glonass G1, Galileo E1 and Beidou B1C and/or QZSS L1 is used.

In some embodiments, the following float solution from a dual antenna MB-RTK is achieved as:

$$X = ( \begin{matrix}\hat{Δ N} \\ \hat{b} \\ \hat{τ}\end{matrix} ) \qquad ( 10 )$$

where
\hat{b} is baseline vector,
\hat{τ} is GNSS receiver clock bias,
[symbol] is single-differential float ambiguity states
   Their variance-covariance can described as Eq (11)

$${Q}_{XX} = ( \begin{matrix}{Q}_{\hat{Δ N} \hat{Δ N}} & {Q}_{Δ \hat{N} \hat{b}} & {Q}_{Δ \hat{N} \hat{τ}} \\ {Q}_{\hat{b} \hat{Δ N}} & {Q}_{\hat{b} \hat{b}} & {Q}_{\hat{b} \hat{τ}} \\ {Q}_{\hat{τ} \hat{Δ N}} & {Q}_{\hat{τ} \hat{b}} & {Q}_{\hat{τ} \hat{τ}}\end{matrix} ) \qquad ( 11 )$$

For simplicity, as a case of a single reference satellite, the single-differential operation between satellites ∇ is formed as:

$$∇ = ( \begin{matrix}1 & 0 & 0 & - 1 & 0 & 0 \\ 0 & 1 & 0 & - 1 & 0 & 0 \\ ⋯ & ⋯ & ⋱ & ⋮ & ⋯ & ⋯ \\ 0 & 0 & 0 & - 1 & 1 & 0 \\ 0 & 0 & 0 & - 1 & 0 & 1\end{matrix} ) \qquad ( 12 )$$

The double-differenced ambiguity vector ∇Δ\hat{N} (to be simplified as Ñ later), their variance-covariance matrix Q_{\hat{N}\hat{N}} and Q_{\hat{N}\hat{b}} covariance of double-differenced ambiguity and baseline, are formed as Equations (13), (14) and (15) respectively.

$$\hat{N} = ∇ * \hat{Δ N} \qquad ( 13 )$$

$${Q}_{\hat{N} \hat{N}} = ∇ * {Q}_{\hat{Δ N} \hat{Δ N}} \qquad ( 14 )$$

$${Q}_{\hat{N} \hat{b}} = ∇ * {Q}_{\hat{Δ N} \hat{b}} \qquad ( 15 )$$

A process for obtaining or finding the fixed ambiguity solution includes solving the integer least squares equation to satisfy the minimum cost function Ω₁(χ²) in Eq (16):

$${Ω}_{1} ( {χ}^{2} ) = {R}_{k} = {( \hat{N} - {N}_{k} )}^{T} {Q}_{\hat{N} \hat{N}}^{- 1} ( \hat{N} - {N}_{k} ) \qquad ( 16 )$$

In some embodiments, for each different integer set (also called a candidate integer ambiguity set, or candidate set of integer ambiguities) Nₖ, a different value of quadratic form Rₖ will be obtained and a single value is obtained for each candidate set Nₖ of integer ambiguities (i.e., integer ambiguities for channel signals received from a set of satellites). For example, an optimal integer set Nₖ that satisfies Equation (16) (e.g., by producing the smallest value of Rₖ and by satisfying a discrimination test) is accepted as the correct integer ambiguity set and is used to produce the final fixed ambiguity solution. In some embodiments, the Least-squares AMBiguity Decorrelation Adjustment (LAMBDA) method is used to perform the search using transformed floating ambiguities. In some embodiments, the transformed integer ambiguities are constructed from the original ambiguities, and are used to recover the original integer ambiguities once the solution for the transformed integer ambiguities has been determined. For example, the advantage of this procedure is that the transformed floating ambiguities have smaller standard deviations and there is a smaller number of integer candidate sets, and thus, the computation time is significantly reduced. In some embodiments, the LAMBDA method involves a discrete search strategy to fix (e.g., determine values of) the integer ambiguities, where two distinct procedures are used for integer ambiguity estimation including: ambiguity decorrelation (or Z-transformation) followed by a discrete search for the integer ambiguities (e.g., the actual integer ambiguity estimation).

In some embodiments, in order to ensure that the transformed ambiguity values have integer characteristics, the transformation matrix Z has only integer entries. In some embodiments, in order to ensure that the original ambiguity values are determined from the transformed ambiguity values, the inverse of the transformation matrix also has only integer entries. Therefore, the matrix Z is an admissible ambiguity transformation if and only if matrix Z has integer entries and its determinant equals 1.

For a given integer ambiguity candidate set N̅, the baseline b̅ and their variance-covariance Q_{b̅b̅} with a fixed ambiguity set are derived in the Equations (17-18):

$$\overline{b} = \hat{b} - {Q}_{\hat{b} \hat{N}} {Q}_{\hat{N} \hat{N}}^{- 1} ( {N}_{k} - \hat{N} ) \qquad ( 17 )$$

$${Q}_{\overline{b} \overline{b}} = {Q}_{\hat{b} \hat{b}} - {Q}_{\hat{b} \hat{N}} {Q}_{\hat{N} \hat{N}}^{- 1} {Q}_{\hat{N} \hat{b}} \qquad ( 18 )$$

In some embodiments, the projector matrix

$${Q}_{\hat{b} \hat{N}} {Q}_{\hat{N} \hat{N}}^{- 1} ,$$

which maps from ambiguity vector into a baseline correction, and variance-covariance Q_{b̅b̅} are computed ahead, before performing the ambiguity search process.

In some embodiments, the dual antenna system is securely mounted on a platform (e.g., a tractor roof), allowing the baseline a priori information between the two antennas to be used as baseline-constrained virtual observations in the observation domain. A baseline-constrained integer ambiguity search criterion is established to validate integer ambiguity resolution in the ambiguity domain. A Kalman Filter estimation algorithm is constructed based on the stability of the integer ambiguity to achieve fast, reliable, and precise heading determination. This method utilizes the baseline a priori information for the ambiguity determination process.

In some embodiments, the baseline constrained solution with a priori baseline information and ambiguity fixed solution b̅ are described as Equations (19), (20), and (21):

$$E ( \begin{matrix}\overline{b} \\ l\end{matrix} ) [ \begin{matrix}\begin{matrix}1 & 0 & 0 \\ 0 & 1 & 0 \\ 0 & 0 & 1\end{matrix} \\ \frac{{b}_{1}}{‖ \overline{b} ‖} \frac{{b}_{2}}{‖ \overline{b} ‖} \frac{{b}_{3}}{‖ \overline{b} ‖}\end{matrix} ] ( \begin{matrix}{b}_{1} \\ {b}_{2} \\ {b}_{3}\end{matrix} ) \qquad ( 19 )$$

$$D ( \begin{matrix}\overline{b} \\ l\end{matrix} ) = ( \begin{matrix}{Q}_{\overline{b} \overline{b}} & 0 \\ 0 & {σ}_{ll}^{2}\end{matrix} ) \qquad ( 20 )$$

$$H = [ \frac{{b}_{1}}{‖ \overline{b} ‖} \frac{{b}_{2}}{‖ \overline{b} ‖} \frac{{b}_{3}}{‖ \overline{b} ‖} ] \qquad ( 21 )$$

where
b is the ambiguity-fixed and baseline constrained baseline solution
l is a priori baseline length.
σᵤ is an uncertainty of the a priori baseline length.
b̅ is the ambiguity fixed baseline solution, with components b₁, b₂, and b₃.

In some embodiments, the baseline length is typically within a threshold length (e.g., such as within a few meters or shorter). In some embodiments, the linearization error for Equation (21) is significant if an inaccurate float solution is used before the ambiguity fixed solution is provided. In some embodiments, the baseline constraint equation (19-21) is resolved after the integer ambiguity set is correctly resolved into integer values.

In some embodiments, the Least Square principle is applied to the above Equations (19-21), which satisfies the following minimum cost function Ω₂(χ²) as:

$${Ω}_{2} ( {χ}^{2} ) = {( b - \overline{b} )}^{T} {Q}_{\overline{b} \overline{b}}^{- 1} ( b - \overline{b} ) + \frac{{( ‖ b ‖ - l )}^{2}}{{σ}_{ll}^{2}} . \qquad ( 22 )$$

In some embodiments, the optimal solution of the equation (22) for a given integer ambiguity set is calculated using:

$$b = \overline{b} + {b}_{x} = \overline{b} + K ( l - ‖ \overline{b} ‖ ) \qquad ( 23 )$$

where

$$K = {Q}_{\overline{b} \overline{b}}^{- 1} \frac{-}{b} \frac{1}{b} {{H}^{T} ( {HQ}_{\overline{b} \overline{b}}^{- 1} {H}^{T} + {σ}_{ll}^{2} )}^{- 1} \qquad ( 24 )$$

$${b}_{x} = K ( l - ‖ \overline{b} ‖ ) \qquad ( 25 )$$

By inserting Equations (23)-(25) into Equation (22), the minimum cost function Ω₂(χ²) for the baseline constrained solution is reformed as:

$${Ω}_{2} ( {χ}^{2} ) = {b}_{x}^{T} {Q}_{\overline{b} \overline{b}}^{- 1} {b}_{x} + \frac{{( ‖ b ‖ - l )}^{2}}{{σ}_{ll}^{2}} \qquad ( 26 )$$

In some embodiments, considering the minimum cost functions Ω₁(χ²) in Equation (16) and Ω₂(χ²) in Equation (26), the total cost function for a given ambiguity set and baseline constrained a prior information is written as Equation (27):

$$Ω ( {χ}^{2} ) = {Ω}_{1} ( {χ}^{2} ) + {Ω}_{2} ( {χ}^{2} ) = {( \hat{N} - {N}_{k} )}^{T} {Q}_{\hat{N} \hat{N}}^{- 1} ( \hat{N} - {N}_{k} ) + {b}_{x}^{T} {Q}_{\overline{b} \overline{b}}^{- 1} {b}_{x} + \frac{{( ‖ b ‖ - l )}^{2}}{{σ}_{ll}^{2}} \qquad ( 27 )$$

In some embodiments, before performing a search process, the variance-covariance (VCV) matrix Q_{b̅b̅} for an ambiguity fixed solution is pre-computed using Equation (18).

In some embodiments, during the search process, for a given integer ambiguity candidate set Nₖ, the ambiguity-fixed baseline vector b̅ is computed in Equation (17), and its corresponding baseline constrained design matrix H is computed in Equation (21). The baseline constrained solution b is computed in Eq (23), and a single value of quadratic form Ω(χ²) can be derived in Eq (27). In some embodiments, for each different integer set Nₖ, a different value of the quadratic form of the minimum cost function Q (x2) will be obtained. In some embodiments, an optimal integer set Nₖ that satisfies Equation (27) (e.g., by producing the smallest value of Ω(χ²), and that also satisfies a discrimination test) is accepted as the correct integer ambiguity set with baseline a priori constraints, and the optimal integer set is used to produce the final fixed ambiguity and baseline constrained solution.

### Dual Antenna Delta Position Change Module (DL1PNAV)

In some embodiments, the basic GNSS carrier observables

$$Δ {Φ}_{r , {L}_{1}}^{s} {λ}_{{L}_{1}}$$

in Equation (9) are formed between adjacent epochs. For example, the GNSS double-differenced carrier observables

$$∇ Δ {Φ}_{r , {L}_{1}}^{s} {λ}_{{L}_{1}}$$

between dual antennas and adjacent epochs is written as Equation (28):

$$∇ Δ {Φ}_{r , {L}_{1}}^{s} {λ}_{{L}_{1}} = ∇ Δ {ρ}_{r}^{s} + ∇ Δ {τ}_{r} + ∇ Δ {ε}_{{Φ}_{r , {L}_{1}}^{s}}$$

where
∇Δ double-difference operator between adjacent epochs and dual antennas;

$$∇ Δ {Φ}_{r , {L}_{1}}^{s}$$

is double-differenced carrier phase observables between dual antennas;

$$∇ Δ {ρ}_{r}^{s}$$

is relative position changes between adjacent epochs and dual antennas;
∇Δτᵣ is double-differenced receiver clock bias change over adjacent epochs between dual antennas; and

$$∇ Δ {ε}_{{Φ}_{r , {L}_{1}}^{s}}$$

is double-differenced carrier phase noise.

In some embodiments, the integer ambiguity is remains constant if no cycle slip occurs. The phase difference between epochs can be used to track changes in position.

In some embodiments, the phase wind-up change and receiver phase bias are lump-summed together as one variable or ignored if their impact is very small after considering the double difference operator between the dual antennas and adjacent epochs. The module called DL1PNAV 276 is based on Equation (28). In some embodiments, the DL1PNAV module is implemented using either the Least Square principle or a Kalman filter. In some embodiments, the DL1PNAV module is used to estimate the position change over an epoch for computing the relative baseline solution between dual antennas.
In some embodiments, for integer-seconds (e.g., except for the first one), two baseline solutions are made available, including a solution from the time synchronized dual antenna moving base RTK solution and a solution from the DL1PNAV estimated baseline changes accumulated over the epoch. Using a similar technique for combining the L1PNAV solution with the RTK or PPP solution, the two baseline vectors are combined using the variance-covariance matrix for the MB-RTK solution and the variance-covariance matrix for DL1PNAV solution (e.g., using Equation 30).

For example, assuming the variance-covariance matrix for the MB-RTK solution is R_{RTK} and the variance-covariance matrix for the DL1PNAV solution is R_{DL1PNAV}, if the sum of the diagonal elements in R_{RTK} is smaller than the sum of the diagonal elements in R_{L1PNAV}, the baseline vector from RTK will be used as the final baseline solution for that particular integer second, that is:

$$\hat{B} = {B}_{RTK} \qquad ( 29 )$$

Otherwise, the two baseline vectors will be combined as in the following equation:

$$\hat{B} = {\hat{B}}_{RTK} + {R}_{RTK} \cdot {( {R}_{RTK} + {R}_{DL 1 PNAV} )}^{- 1} \cdot ( {B}_{DL 1 PNAV} - {B}_{RTK} ) \qquad ( 30 )$$

In some embodiments, with the new baseline solution available for a respective integer second, the baseline vector beyond the respective integer second will also be updated using equation (28).

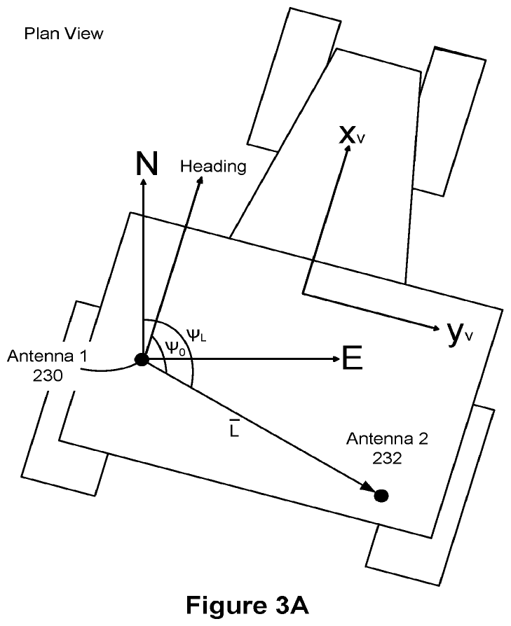

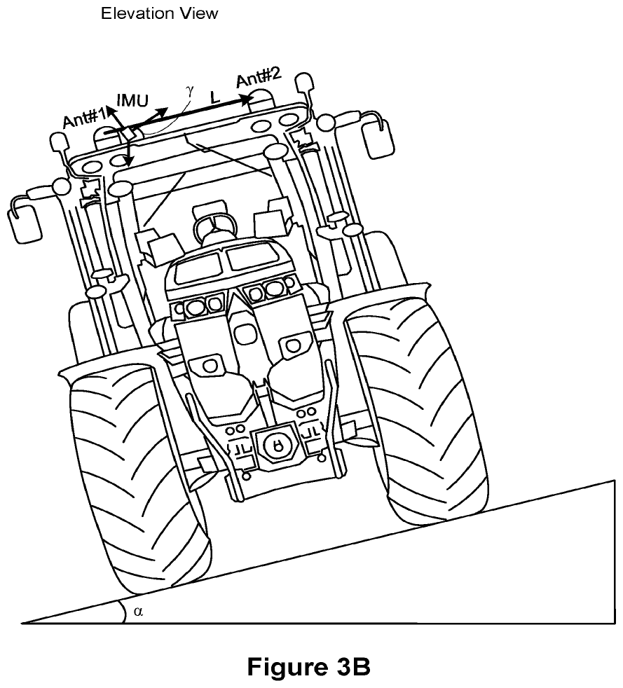

As described herein, the dual antenna capability provides improved GNSS positioning for mobile objects. For example, utilizing two antennas with a single receiver allow generating a more precise positioning and orientation solution. In some embodiments, as described below with reference to FIG. 3A, the dual antenna system is further integrated with IMU sensors (e.g., IMU sensors 224, FIG. 1C) to improve heading, roll and pitch determinations used for guidance and/or automation solutions.

For example, for two antennas that are longitudinally installed with a base at a rear of an object and a rover in the front of the object, the heading angle α and accuracy σ_{α} can be computed as:

$$α = {tan}^{- 1} ( E / N ) , \qquad ( 31 )$$

$${σ}_{a} = \frac{\sqrt{\frac{{σ}_{E}^{2}}{{N}^{2}} + \frac{{E}^{2} {σ}_{N}^{2}}{{N}^{4}}}}{1 + {( \frac{E}{N} )}^{2}} = \frac{\sqrt{{E}^{2} {σ}_{N}^{2} + {N}^{2} {σ}_{E}^{2}}}{{N}^{2} + {E}^{2}} , \qquad ( 32 )$$

where N and E are the baseline North and East components, respectively, and

$${σ}_{N}^{2} and {σ}_{E}^{2}$$

are the corresponding variances.

In some embodiments, the two antennas are laterally installed on the mobile object (e.g., a vehicle). In some embodiments, when the base is on the left of the object, the heading angle offset can be calculated with the following equation:

$${ψ}_{0} = {tan}^{- 1} ( - N / E ) , \qquad ( 33 )$$

In some embodiments, the inclination angle φ, (e.g., pitch or roll) that depends on the system installation, is computed as:

$$ϕ = {sin}^{- 1} ( \frac{U}{\sqrt{{N}^{2} + {E}^{2} + {U}^{2}}} ) , \qquad ( 34 )$$

where U is vertical offset component.

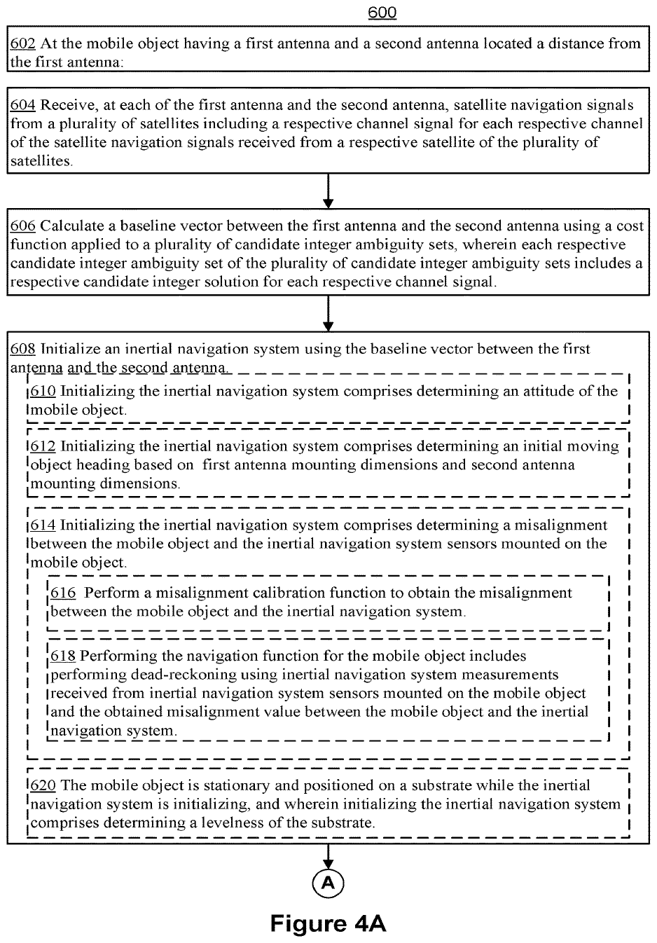

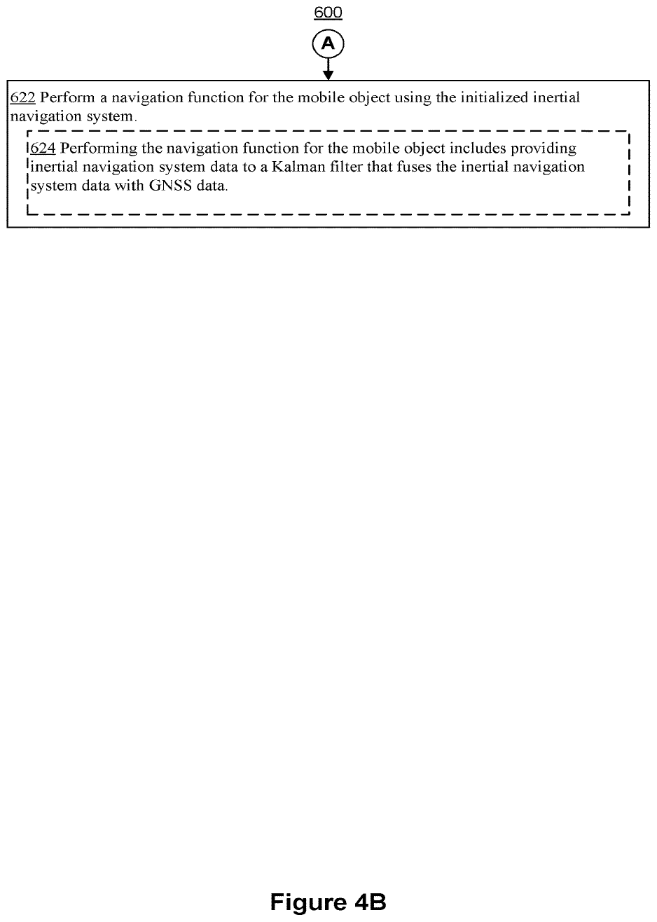

As such, the method described above (e.g., and the methods described herein with reference to FIGS. 4A-4B and 5A-5B) applies known baseline constraint information during the ambiguity search process before the ambiguity is fixed. In some embodiments, the known baseline length is considered as the virtual measurement for Kalman filter, which is updated for both the MB-RTK module (e.g., after the ambiguity is fixed) and the DL1PNAV module. In some embodiments, the method is based on a modification of the LAMBDA method, where the a priori information on the baseline length is exploited in the search process. In some embodiments, the integer ambiguity is searched by exploring a baseline length constrained solution which iteratively reduces the size of the search space, resulting in fast convergence to the sought-after solution. This approach enables almost instantaneous ambiguity resolution, even for a dual antenna system using a single-frequency secondary antenna, and also provides position and heading for the dual antenna system at a high update rate.

### Inertial Navigation Using Dual Antenna System

FIGS. 3A-3B illustrate a system that initializes and/or calibrates an inertial navigation system (INS) using a baseline vector between two antenna of a mobile object in accordance with some embodiments.

In some embodiments, to navigate with INS, a dead reckoning system first needs to be initialized. In some embodiments, heading angle is the most difficult of the INS states to be determined when using GNSS along with an industrial grade IMU. For example, when being powered on statically, the heading angle cannot be determined until the first motion of the system. In some embodiments, by examining the ground vehicle course information together with the IMU measurements, the angle heading can be determined and used to initialize the INS. However, there are possibilities that the information is not incorporated properly and this may lead to an erroneous heading initialization. Additionally, the course could be inaccurate due to ground vehicle maneuvers, as the course is only aligned with heading when the velocity vector is coincident with the vehicle forward direction. Without proper compensation, this course-based heading initialization can be very inaccurate, which could cause convergence issues.

With GNSS aiding, INS can provide continuous position and attitude solutions. In some embodiments, the drifting nature of the INS solution can be largely mitigated. Due to ground vehicle dynamics, however, the heading angle, along with the gyro bias, may not be well estimated. In some embodiments, in order to provide non-drifting heading solutions for ground vehicles, the vehicle requires frequent lateral and/or longitudinal accelerations, which is not realistic in many applications. Accordingly, determining a robust heading solution remains a challenging task many of ground vehicle applications.

### Dual Antenna System Setup

In some embodiments, the first step to setup the system illustrated in FIG. 3A requires mounting the two antennas on a mobile object (e.g., on a rigid vehicle top). Although not required in all embodiments, in some embodiments, the two antennas are mounted high enough vertically such that the GNSS signals will not be blocked by the object itself. In some embodiments, blocked signals may degrade the system final performance, but will increase system applicability. In some embodiments, the spatial distance between the two antennas is maximized on the mobile object in order to increase the system accuracy, as angular accuracy typically increases with baseline length. In some embodiments, to support more precise operation, the exact mounting locations with respect to an object reference point (e.g., a tractor reference point) must be provided.

In some embodiments, the second step to setup the system illustrated in FIG. 3A is to mount the IMU on the same mobile object (e.g., on the rigid body vehicle). In some embodiments, an industrial grade IMU is used (e.g., which can minimize the cost of the system). It will be understood that the system setup described herein is not limited to IMU models or technology varieties. In some embodiments, the IMU is mounted anywhere on the mobile object with any orientation. In some embodiments, it is suggested that the IMU be collocated with the GNSS receiver or antenna (e.g., to save cost and to simplify the implementation). In some embodiments, the exact mounting location of the IMU with respect to the antenna reference point is provided to the system, either directly or indirectly. In some embodiments, a digital processor combines the GNSS measurements and IMU measurements to produce continuous fused position, velocity, and attitude solutions.

### Dual Antenna Aided INS Initialization

An INS is naturally a dead reckoning system. In some embodiments, to propagate an INS forward in time, the initial state along with the IMU measurements over time must be obtained. In some embodiments, with GNSS signals also available, the position of the object is derived. For example, basic pseudo range measurement processing is used to obtain a location of the system with meter-level accuracy. In some embodiments, carrier phase based techniques, such as Precise Point Positioning (PPP) or RTK, are used to achieve centimeter-level accuracy of the position. In some embodiments, any such position solution is used to initialize the INS position states. In some embodiments, GNSS velocity is derived from carrier phase time differencing, and the velocity states of the object are initialized with GNSS aiding.

In some embodiments, the attitude of the object (e.g., ground vehicle attitude) is described using Euler angles: roll, pitch, and yaw. In some embodiments, these angles are measured with respect to a local level NED frame. Among all the states that need to be initialized in the INS, these are typically the most difficult ones to be obtained accurately. In some embodiments, when the position of the ground vehicle is static and the IMU is aligned with the vehicle body, the x-axis accelerometer readings and the y-axis readings are used to extract the roll and pitch angles. In some embodiments, when there are no accelerations acting on the IMU other than gravity, the x-axis accelerometer and the y-axis accelerometer are used to directly measure the roll angle and pitch angles of the object. Based on the actual measured values, the initial roll and pitch angles are calculated.

In some embodiments, the initial yaw angle on the other hand is typically not as easily obtained and requires vehicle dynamics. In some embodiments, a dual antenna system is used to solve for initial heading with or without any vehicle dynamics. In some embodiments, the baseline vector in an earth-centered, earth-fixed (ECEF) coordinate frame is solved in real time using the Moving Base RTK (MB-RTK) algorithm. In some embodiments, once the ECEF baseline coordinates are available, they can be rotated to the local level frame. The local level frame components are subsequently used to solve for the true ground vehicle heading, using the equations below:

$${ψ}_{0} = arctan \frac{{l}_{y}^{v}}{{l}_{x}^{v}} \qquad ( 35 )$$

$${ψ}_{L} ( t ) = arctan \frac{{l}_{E}^{n} ( t )}{{l}_{N}^{n} ( t )} \qquad ( 36 )$$

$${ψ}_{v} ( t ) = {ψ}_{L} ( t ) - {ψ}_{0} \qquad ( 37 )$$

ψ₀: heading angle offset from dual antenna setup;

$${l}_{x}^{v} , {l}_{y}^{v} :$$

antenna relative position horizontal components in vehicle frame;

$${l}_{E}^{n} ( t ) , {l}_{N}^{n} ( t ) :$$

MB-RTK baseline components in local level frame;
ψ_{L}(t): MB-RTK baseline bearing angle;
ψ_{L}(t): vehicle true heading.

For example, FIG. 3A illustrates mounting two antenna on a mobile object, and a heading angle offset from the dual antenna setup.

### Dual Antenna Based IMU Misalignment Calibration

In some embodiments, the proposed dual antenna IMU misalignment calibration procedure is performed automatically. For example, the system utilizes a dual antenna configuration to determine the ground's levelness and excludes a corresponding determined misalignment from the IMU's inclination calculation. In some embodiments, the mounting misalignment may be a few degrees off, which is unacceptably large for terrain compensation, whereas the antenna assembly dimension error, can be measured to within a few millimeters and thus produces only a fraction of the degree angle errors (e.g., depending on the separation distance of the two antennas). In some embodiments, once the baseline vector is solved using the MB-RTK algorithm, the ground levelness is calculated. In some embodiments, the ground levelness is subtracted from the IMU inclination calculation to obtain the desired misalignment values.

In the example illustrated in FIG. 3B, the two antennas are laterally aligned on the mobile object (e.g., on the tractor cab top). In some embodiments, the manufacturing and assembly processes enable the two antennas to be guaranteed to be within a few millimeters of the designed location. In some embodiments, the angular orientation of each the two antennas barely affects the calibration and hence can be ignored. In some embodiments, the IMU is mounted directly on the same cab rooftop of a tractor as the dual antennas, or alternatively the IMU can be assembled within the GNSS receiver/antenna enclosure. In some embodiments, after the dual antenna system fixes the baseline vector between the two antennas, the inclination angle of this baseline is calculated. Since the two antennas are mounted exactly along the tractor lateral axis in this simplified setup, this inclination angle reflects the roll angle offset due to terrain levelness:

$$α = arcsin \frac{{l}_{D}^{n}}{‖ {L}^{n} ‖} \qquad ( 38 )$$

where
α: terrain inclination angle along lateral axis;
Lⁿ: baseline vector in local level frame,

$${L}^{n} = [ \begin{matrix}{l}_{N}^{n} \\ {l}_{E}^{n} \\ {l}_{D}^{n}\end{matrix} ]$$

In some embodiments, the IMU roll angle, which combines terrain inclination angle α and the misalignment angle γ, is calculated with gravity readings on the accelerometer using the equation:

$${ϕ}_{IMU} = arctan \frac{- {f}_{y}}{{f}_{z}} \qquad ( 39 )$$

where
φ_{IMU}: IMU roll angle when the mobile object and its navigation system are static;
f_{y}: IMU reading on y axis;
f_{z}: IMU reading on z axis.

In some embodiments, by taking multiple measurements and running a low pass filter, the noise from both the terrain inclination calculation and IMU roll angle calculation are effectively removed. In some embodiments, the roll angle misalignment is then derived as:

$$γ = {\overline{ϕ}}_{IMU} - \overline{α} \qquad ( 40 )$$

where
φ̅_{IMU}: filtered IMU roll angle;
α̅: filtered terrain inclination angle, as shown in FIG. 3B.

In some embodiments, the two antennas illustrated in FIG. 3B are assumed to be mounted with the same height. In some embodiments, if there is a height difference, the corresponding inclination angle offset needs to be removed from the calculation, as:

$$γ = {\overline{ϕ}}_{IMU} - ( \overline{α} - {α}_{0} ) \qquad ( 41 )$$

where
α₀: antenna inclination angle offset due to antenna height difference.

In some embodiments, if the two antennas are longitudinally laid out on top of the tractor cab, the misalignment pitch angle can be calculated using similar calculations.

### Dual Antenna System Relative Mounting Dimension Estimation

In some embodiments, the proposed method described with reference to FIGS. 6A-6B provides a feasible and reliable way to estimate the dual antenna system mounting dimensions and optionally to validate the factory provided dimensions. In some embodiments, the antenna mounting dimensions are estimated, using the two-step procedure to remove IMU misalignment error and attitude error, with an extended Kalman filter implementation.

In some embodiments, the relative dimensions with respect to the vehicle platform are modeled as random walks with small dynamic noises:

$${\dot{L}}^{v} = w \qquad ( 42 )$$

where
L^{v}: vector from main antenna to second antenna in vehicle frame;
w: dynamic noise.

In some embodiments, the measurements are the MB-RTK baselines. For example, through mathematical manipulation, the measurement equation can be derived as the following form:

$${L}^{e} - {R}_{b}^{e} {\hat{L}}^{v} + {R}_{b}^{e} ( {\hat{L}}^{v} \times ) γ = {R}_{b}^{e} δ {L}^{v} + v \qquad ( 43 )$$

where
L^{e}: MB-RTK baseline vector in Earth Centered Earth Fixed (ECEF) frame;

$${R}_{b}^{e} :$$

IMU direction cosine matrix from IMU body frame to ECEF frame;
\hat{L}^{v}: relative dimension estimation in vehicle frame,

$${\hat{L}}^{v} = [ \begin{matrix}{\hat{l}}_{x}^{v} \\ {\hat{l}}_{y}^{v} \\ {\hat{l}}_{z}^{v}\end{matrix} ]$$

\hat{L}^{v}×: skew symmetric matrix of vector \hat{L}^{v},

$${\hat{L}}^{v} \times = [ \begin{matrix}0 & - {\hat{l}}_{z}^{v} & {\hat{l}}_{y}^{v} \\ {\hat{l}}_{z}^{v} & 0 & - {\hat{l}}_{x}^{v} \\ - {\hat{l}}_{y}^{v} & {\hat{l}}_{x}^{v} & 0\end{matrix} ]$$

γ: IMU misalignment with respective to vehicle frame,

$$γ = [ \begin{matrix}{γ}_{ϕ} \\ {γ}_{θ} \\ {γ}_{ψ}\end{matrix} ]$$

δL^{v}: relative baseline error vector in vehicle frame;
v: measurement noise.

In some embodiments, with the system dynamics equation and the measurement equation, an extended Kalman filter is implemented to estimate the relative dimensions between the two antennas. In some embodiments, to mitigate the side effects from IMU misalignment and inaccurate attitude error, a three-step process is used, including: in step one, the IMU and ground vehicle misalignment are calibrated. In some embodiments, the roll misalignment γ_{φ} and pitch misalignment γ_{θ} are obtained using the classic two-point calibration method. Alternatively, in some embodiments, the roll misalignment γ_{φ} and pitch misalignment γ_{θ} are dynamically calibrated. In some embodiments, the heading misalignment γ_{ψ} is done at the factory when assembling the GNSS receivers.

In some embodiments, in step two, the attitude angles are converged. For example, for GNSS and INS integration, the roll angle and pitch angle are typically observable, while the heading angle is not. In some embodiments, to establish a well observed heading angle, a guidance system (e.g., AutoTrac or another steering guidance system) for the mobile object is used on a single straight line, and is optionally repeated multiple times. In some embodiments, the Terrain Compensation Module (TCM) heading converges to an accurate value. In some embodiments, following the driving pattern according to the guidance system, the roll and pitch angles along with the heading will be unbiased.

Accordingly, steps 1 and 2 provide the IMU-vehicle misalignment and the attitude with very small errors. In some embodiments, step three uses an extended Kalman filter that refines the estimate of the relative dimensions between the two antennas. In some embodiments, with an industrial grade IMU, the accuracy can be millimeter level.

### INS and IMU Initialization and Mobile Object Navigation

FIGS. 4A-4B illustrate flowcharts for a method 600 performed by a system (e.g., the dual antenna system illustrated in FIG. 2) for navigating a mobile object (e.g., a vehicle, tractor, or other object) according to signals from satellites in accordance with some embodiments. In some embodiments, the system initializes an INS using a baseline vector between two antennas, as described with reference to FIGS. 3A-3B.

To that end, the method 600 is performed by a system that includes a mobile object having a first antenna and a second antenna located a distance (e.g., a fixed, or invariant distance) from the first antenna (602).

In some embodiments, the system receives (604), at each of the first antenna and the second antenna, satellite navigation signals from a plurality of satellites including a respective channel signal for each respective channel of the satellite navigation signals received from a respective satellite of the plurality of satellites.

In some embodiments, the system calculates (606) a baseline vector between the first antenna and the second antenna using a cost function applied to a plurality of candidate integer ambiguity sets, wherein each respective candidate integer ambiguity set of the plurality of candidate integer ambiguity sets includes a respective candidate integer solution for each respective channel signal.

In some embodiments, the system initializes (608) an inertial navigation system (e.g., an IMU) using the baseline vector between the first antenna and the second antenna.

In some embodiments, the system performs (622) a navigation function for the mobile object using the initialized inertial navigation system.

In some embodiments, initializing the inertial navigation system comprises (610) determining an attitude of the mobile object.

In some embodiments, initializing the inertial navigation system comprises (612) determining (e.g., while the mobile object is stationary or in motion) an initial moving object heading based on first antenna mounting dimensions (e.g., coordinates and rotations) and second antenna mounting dimensions. In some embodiments, the mounting dimensions are provided by the factory that installed the dual antennas on the mobile object.

In some embodiments, initializing the inertial navigation system comprises (614) determining a misalignment between the mobile object and the inertial navigation system sensors mounted on the mobile object. In some embodiments, the misalignment is an angular misalignment, with respect to at least one rotational axis, between the mobile object and IMU sensors (224, FIG. 1C) mounted on the mobile object (e.g., the one rotational axis could be the roll axis or the pitch axis, depending on implementation needs). In some embodiments, in cases where two axis misalignment is needed, a three antenna system is used. In some embodiments, initializing the inertial navigation system comprises determining, while the mobile object is stationary, an angular misalignment, with respect to two rotational axes, between the mobile object and IMU sensors mounted on the mobile object (e.g., the two rotational axes for which rotational misalignments are determined during initialization are the roll and pitch axes, and the determined misalignment comprises a roll misalignment and a pitch misalignment).

In some embodiments, the system performs (616) a misalignment calibration function to determine the misalignment between the mobile object and the inertial navigation system (e.g., as described with reference to the misalignment angle γ (Equations (40-41))).

In some embodiments, performing the navigation function for the mobile object includes (618) performing dead-reckoning navigation using inertial navigation system measurements received from inertial navigation system sensors mounted on the mobile object and the obtained misalignment value between the mobile object and the inertial navigation system.

In some embodiments, the mobile object is (620) stationary and positioned on a substrate while the inertial navigation system is initializing, and wherein initializing the inertial navigation system comprises determining a levelness of the substrate (e.g., the ground on which the mobile object is positioned).

In some embodiments, performing the navigation function for the mobile object includes (624) providing inertial navigation system data (e.g., and processed dual antenna data) to a Kalman filter that fuses the inertial navigation system data with GNSS data.

It will be understood that although the terms “first,” “second,” etc. may be used herein to describe various elements, these elements should not be limited by these terms. These terms are only used to distinguish one element from another. For example, a first element could be termed a second element, and, similarly, a second element could be termed a first element, without changing the meaning of the description, so long as all occurrences of the “first element” are renamed consistently and all occurrences of the second element are renamed consistently. The first element and the second element are both elements, but they are not the same element.

The terminology used herein is for the purpose of describing particular embodiments only and is not intended to be limiting of the claims. As used in the description of the embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method for navigating a mobile object according to signals from satellites, the method comprising:
at the mobile object having a first antenna and a second antenna located a distance from the first antenna,
receiving, at each of the first antenna and the second antenna, satellite navigation signals from a plurality of satellites including a respective channel signal for each respective channel of the satellite navigation signals received from a respective satellite of the plurality of satellites;
calculating a baseline vector between the first antenna and the second antenna using a cost function applied to a plurality of candidate integer ambiguity sets, wherein each respective candidate integer ambiguity set of the plurality of candidate integer ambiguity sets includes a respective candidate integer solution for each respective channel signal;
initializing an inertial navigation system using the baseline vector between the first antenna and the second antenna; and
performing a navigation function for the mobile object using the initialized inertial navigation system.

2. The method of claim, wherein initializing the inertial navigation system comprises determining an attitude of the mobile object.

3. The method of claim, wherein initializing the inertial navigation system comprises determining an initial moving object heading based on first antenna mounting dimensions and second antenna mounting dimensions.

4. The method of claim, wherein initializing the inertial navigation system comprises determining a misalignment between the mobile object and inertial navigation system sensors mounted on the mobile object.

5. The method of claim, including performing a misalignment calibration function to obtain the misalignment between the mobile object and the inertial navigation system.

6. The method of claim, wherein performing the navigation function for the mobile object includes performing dead-reckoning using inertial navigation system measurements received from inertial navigation system sensors mounted on the mobile object and the obtained misalignment value between the mobile object and the inertial navigation system.

7. The method of claim, wherein the mobile object is stationary and positioned on a substrate while the inertial navigation system is initializing, and wherein initializing the inertial navigation system comprises determining a levelness of the substrate.

8. The method of claim, wherein performing the navigation function for the mobile object includes providing inertial navigation system data to a Kalman filter that fuses inertial navigation system data with Global Navigation Satellite System (GNSS) data.

9. A device for navigating a mobile object according to signals from satellites, comprising:
one or more processors; and
memory storing instructions that, when executed by the one or more processors, cause the device to perform a set of operations, comprising:
receiving, at each of a first antenna and a second antenna, satellite navigation signals from a plurality of satellites including a respective channel signal for each respective channel of the satellite navigation signals received from a respective satellite of the plurality of satellites;
calculating a baseline vector between the first antenna and the second antenna using a cost function applied to a plurality of candidate integer ambiguity sets, wherein each respective candidate integer ambiguity set of the plurality of candidate integer ambiguity sets includes a respective candidate integer solution for each respective channel signal;
initializing an inertial navigation system using the baseline vector between the first antenna and the second antenna; and
performing a navigation function for the mobile object using the initialized inertial navigation system.

10. A navigation system for navigating a mobile object according to signals from satellites, comprising:
a receiver for receiving, from each of a first antenna and a second antenna located a distance from the first antenna, satellite navigation signals from a plurality of satellites including a respective channel signal for each respective channel of the satellite navigation signals received from a respective satellite of the plurality of satellites, wherein the first antenna and the second antenna are mounted on the mobile object at the distance from each other; and
a computer system, coupled to the receiver, for:
calculating a baseline vector between the first antenna and the second antenna using a cost function applied to a plurality of candidate integer ambiguity sets, wherein each respective candidate integer ambiguity set of the plurality of candidate integer ambiguity sets includes a respective candidate integer solution for each respective channel signal;
initializing an inertial navigation system using the baseline vector between the first antenna and the second antenna; and
performing a navigation function for the mobile object using the initialized inertial navigation system.
